(19) United States
(12) Patent Application Publication
(10) Pub. No.: US 2009/0076857 A1
(43) Pub. Date: Mar. 19, 2009

(54) SYSTEMS AND METHODS FOR MANAGING PATIENT PHARMACEUTICAL CARE

(75) Inventors: Magdy A. ELETREBY, Dana Point, CA (US); Mohammed N. ELETREBY, Huntington Beach, CA (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., OVERLAND PARK, KS (US)

(21) Appl. No.: 12/324,288

(22) Filed: Nov. 26, 2008

Related U.S. Application Data
(63) Continuation of application No. 09/253,606, filed on Feb. 19, 1999, now abandoned.

(51) Int. Cl. G06Q 50/00

(52) U.S. Cl. 705/3; 705/2

(57) ABSTRACT

Systems and methods are described for allowing a pharmacist to practice pharmaceutical care in an accurate and efficient manner. The present invention provides the systems for gathering, organizing, and maintaining the necessary clinical and patient data, and providing pharmacists access thereto, through integrated computer software. The clinical data classifies drugs into therapeutic classes, and for each class there is associated therewith known indications, contra-indications, recommended dosages, known adverse reactions, and drug interactions. A clinical database and a patient database are used. In the clinical database, each drug is assigned a unique identification code including a therapeutic cross reference (TXR). The TXR allows access to information associated with the drug's adverse reactions, and dosage recommendations, and also to disease indications and contra-indications via a link to the ICD-9s (International Classification of Diseases) associated with the diseases. The patient data includes patient diagnosis profiles and allergy profiles.

### CROSS-REFERENCE TO RELATED APPLICATIONS

This application is a continuation application of U.S. application Ser. No. 09/900,278 filed Jul. 6, 2001, entitled “SYSTEMS AND METHODS FOR MANAGING PATIENT PHARMACEUTICAL CARE,” which was a continuation of U.S. application Ser. No. 09/253,606 filed Feb. 19, 1999, now abandoned, the contents of each application is hereby incorporated by reference.

### STATEMENT REGARDING FEDERALLY SPONSORED RESEARCH OR DEVELOPMENT

Not applicable.

### TECHNICAL FIELD

The present invention relates generally to health care management, and more particularly to systems and methods for providing comprehensive pharmaceutical care to patients.

### BACKGROUND OF THE INVENTION

Prior to 1980, most prescription drugs were dispensed from small, independently-owned pharmacies, and the role of the pharmacist was essentially limited to dispensing the prescribed drugs. Consumers preferred the personal, caring service of their local community pharmacist. However, as the research and development associated with developing new drugs became more costly and competitive, the prices charged for the drugs accelerated rapidly. While in the past most consumers had paid for relatively inexpensive prescription drugs out-of-pocket, the price increases of the mid- to late-80s found workers and retirees clamoring for prescription drug coverage from their employers and insurance plans. The market-sensitive insurance companies complied with these demands, making it even easier for physicians and consumers to utilize these potent new compounds since neither group was directly responsible for purchasing them.

As use continued to skyrocket, the costs to employers and insurance companies also rose dramatically. In an effort to control their expenses, the payers began to economize, by decreasing the professional fees and ingredient reimbursement formulas paid to pharmacies. At the same time, pharmaceutical manufacturers, eager to have their new medications used in hospitals, health maintenance organizations and long term care facilities, slashed their prices to these buyers and piled their profit demands on the backs of independent and chain community pharmacists. This double pressure—reimbursement cuts from payers and price increases from manufacturers—took its toll on the smaller independent pharmacies, and a large number of the nation's independently owned pharmacies were forced to close.

Dispensing prescriptions in large volumes became an economic necessity, leading to the growth of large chain drugstores, mail order drug delivery companies and in-house managed care/HMO pharmacies. Despite increasing the number of prescriptions dispensed, many large pharmacies cut the number of pharmacists on staff, replacing their function with technicians and automated dispensing systems. In an effort to economize even further, most managed care organizations began using ever-changing formularies (restricted drug lists), and required consumers to obtain chronic medications from supposedly cheaper mail order companies.

The changing economics of the health care industry, and particularly the pharmacy industry, as described above, resulted in some undesirable consequences for the basic pharmacy consumer—that is, the patient. For example, the pressures of managed care drastically reduced the amount of time available for communication between patients, physicians and pharmacists. In addition, patients typically did not receive all of their medications from the same pharmacy, and the overall therapy analysis function of the pharmacist was therefore often lost. Thus, despite receiving more potent and effective medications, consumers knew less about the proper use of these medications, and received lesser quality service.

Over the past ten years or so, in an attempt to resolve some of the aforementioned side-effects of the changing industry, “pharmaceutical care” evolved in the pharmacy profession. Pharmaceutical care teaches that pharmacists can and should be held responsible for assuring the appropriate outcomes of medication therapy. Some of the general functions of pharmaceutical care include establishing clear goals of therapy, educating patients on the optimal use of medications, monitoring the effects of the medications, measuring and documenting the outcomes, and reporting on the results to the patient, prescribing doctors, and payers.

To accomplish these functions, and others, the pharmacist typically must consult various sources of information. For example, voluminous clinical reference materials regarding the composition of drugs, their uses, side effects, adverse combinations, etc., are required. Reviewing and analyzing the materials typically involves a large amount of time. In addition, patient records describing the patient's history, as well as current state of health, are required. Follow-up examinations or surveys are needed to evaluate the success of a particular drug or treatment program, or to evaluate if the drug is being properly used. And information as to the effectiveness of a treatment, the improper use of a drug, possible alternative treatments, etc., is usually reported to patients, payers, and physicians.

Having multiple sources of information, typically in various information media, makes it difficult for a pharmacist to practice pharmaceutical care in an accurate and efficient manner. Thus, it would be desirable if the information required to perform the core tasks of pharmaceutical care could be managed and otherwise processed from a centralized point of access, allowing pharmacists to spend more time practicing pharmaceutical care, and less time performing tasks to enable them to do so.

### BRIEF SUMMARY OF THE INVENTION

The present invention describes clinical information resource and documentation systems, and methods of their use. The invention facilitates the provision of pharmaceutical care and disease management by pharmacists in a variety of practice settings. The data associated with the present invention includes clinical data, and patient data.

The clinical data classifies drugs into therapeutic classes, and for each class there is associated therewith known indications, contra-indications, recommended dosages, known adverse reactions, and drug interactions. Each drug is assigned a unique identification code. The code may include a therapeutic cross reference (TXR) as well as other data, but preferably the code itself is the TXR, and the TXR may be associated with a class, subclass, or specific drug. Preferably, the high-order characters of the TXR represent the drug's class, and the next order of characters represent the drug's subclass. Further orders represent finer classifications. Thus, an eight-character TXR may have the first two characters representing a class, the next four representing a subclass, and the next two representing the specific drug within the class and subclass. The TXR allows access to information associated with the drug's disease indications and contra.-indications via a link to the ICD-9s (International Classification of Diseases) associated with the diseases. The TXR also has associated therewith, data representing recommended dosages and adverse reactions.

The patient data includes, for each patient, a diagnosis profile and an allergy profile. The diagnosis profile includes known disease states of the patients. The allergy profile includes patient allergies, cross-sensitivities, and intolerance. Accessing the available clinical data and patient data via a computer software interface, the pharmacist is able to practice pharmaceutical care in an accurate and efficient manner.

The present invention allows pharmacists to use a common approach to providing care throughout all disease states and healthcare related issues. Pharmacists are able to manage patient diseases (Disease Management), perform clinical queries to gather factual information (Clinical Query), document intervention in the patient treatment (Pharmacist Interventions), analyze and evaluate the results of patient therapy (Evaluating Humanistic Outcomes and Evaluating Clinical Outcomes), and report the results to necessary parties (Reporting Results), all through use of an integrated software solution. In this application, the examples and descriptions refer to a “pharmacist” as the person performing the methods described herein. However, the invention is not to be so limited, as any person, such as a nurse, doctor, assistant, may also perform the methods described herein, using the systems and computer software described herein.

Disease management includes various interrelated activities designed to foster sound clinical decisions. For a selected patient, disease management includes documenting the patient's current drug therapy plan (Patient Current Therapy), evaluating the drug therapy in relation to the patient's indications (Drug Use Evaluation), determining any intervention necessary to correct the current therapy plan (Therapy Assessment), and constructing a plan to optimize the patient's therapy (Pharmacist Care Plan).

Clinical Query includes queries based upon patient, disease, drug, drug class, or adverse reactions. Patient-based queries are used to provide possible drug treatments for a given medical condition (diagnosis) of a selected patient, and to provide clinical “alerts” due to any of the patient's co-existing conditions (other disease states and allergies). Disease-based queries are used to provide possible drug treatments for a selected medical condition, and to provide clinical alerts due to hypothetical co-existing conditions, not necessarily attached to a specific patient. Drug-based queries are used to access full prescribing information on any drug in the database and to selectively zero in on the information category of special interest. Drug-class-based queries are used to provide comparison among all drugs in a specific therapeutic class, with full prescribing information on each drug in the class, and to selectively zero in on the information category of special interest. Queries based upon adverse reactions are used to identify therapeutic drug classes and to selectively identify members of each class and the likelihood to which they may cause a given adverse reaction.

Pharmacist Intervention describes the process by which the pharmacist documents any interventions performed in order to be compensated by the patient's insurance provider. The interventions may be clinical in nature, or they may be to educate the patient or to assess the patient's compliance with the prescribed treatment.

Evaluating Outcomes involves taking steps to improve a patient's quality of life (QOL). The evaluation of the humanistic outcomes is generally done through the evaluation of the patient's responses to standardized surveys. The survey answers may be input to the system during a counseling session, or from a printed questionnaire filled out by the patient. The evaluation of clinical outcomes is performed by analyzing results of treatment to selected patients.

Reporting Results involves obtaining essential information that will help the care provider in making critical decisions that affect the health care delivery to the patient. The reports generated may be based upon specified patient characteristics, drug uses, therapy assessments, interventions, responses, recommendations, or clinical outcomes.

Thus, in one aspect of the present invention, integrated software with access to clinical and patient data is used by a pharmacist to determine an appropriate drug therapy for a particular patient, taking into account the patient's allergies, drug interactions, the patient's history, and the patient's present disease state. In another aspect, the software communicates with an independent or integrated dispensing software, to obtain the requested prescribed drugs. In another aspect, the pharmacist uses the software to monitor the patient's progress based upon information provided by the patient, and to report thereon.

Other objects and advantages of the present invention will be apparent from the detailed description which follows, when read in conjunction with the associated drawings.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIGS. 1a, 1b, and 1c are block diagrams illustrating the hierarchical structure of the various features of a preferred embodiment of the present invention.

FIG. 2 is a flowchart illustrating the steps involved in the Patient Current Therapy portion of the Disease Management aspect of the present invention.

FIG. 3 is a flowchart illustrating the steps involved in the Drug Use Evaluation portion of the Disease Management aspect of the present invention.

FIG. 4 is a flowchart illustrating the steps involved in the Pharmacist Care Plan portion of the Disease Management aspect of the present invention.

FIG. 5 is a flowchart illustrating the steps involved in a Patient-based Query portion of the Clinical Query aspect of the present invention.

FIG. 6 is a flowchart illustrating the steps involved in a Disease-based Query portion of the Clinical Query aspect of the present invention.

FIG. 7 is a flowchart illustrating the steps involved in a Drug-based Query portion of the Clinical Query aspect of the present invention.

FIG. 8 is a flowchart illustrating the steps involved in a Drug class-based Query portion of the Clinical Query aspect of the present invention.

FIG. 9 is a flowchart illustrating the steps involved in an Adverse reaction-based Query portion of the Clinical Query aspect of the present invention.

FIG. 10 is a flowchart illustrating the steps to involved in preparing a PCCF Form.

FIG. 11 is a flowchart illustrating the steps to involved in preparing a HCFA 1500 Form.

FIG. 12 is a flowchart showing the steps involved in creating humanistic outcome surveys.

FIG. 14 is a flowchart showing the steps involved in creating Drug Utilization Reports.

FIG. 15 is a flowchart showing the steps involved in creating Therapy Assessment Reports.

FIG. 16 is a flowchart showing the steps involved in creating Clinical Outcome Reports.

FIG. 17a is a sample report produced by using the systems and methods of the present invention, showing some of the various monitoring parameters that are available for tracking.

### DETAILED DESCRIPTION OF THE INVENTION

A preferred embodiment of the present invention is implemented in a computer software application, such as ApotheCare®-2000 Pharmaceutical Care Program, by Etreby Computer Company, Inc., of La Palma, Calif. A User's Guide for the ApotheCare®-2000 Pharmaceutical Care Program is attached hereto as Appendix A, with detailed descriptions of available functions.

The present invention requires at least patient data and clinical data, which may be stored in separate independent databases, or in a single integrated database. The patient data is preferably input via electronic patient charts, and changes continuously as new patients are added, patient drug treatments change, or other demographic, administrative, lifestyle, or other information for a patient changes. The clinical database is preferably a collection of integrated databases, prepared and reviewed by qualified medical and research personnel to ensure that the information is accurate and comprehensive. The clinical database may be updated on a regular basis, such as daily, weekly, monthly, etc., to account for clinical information that is newly discovered or newly-accepted. The clinical data classifies drugs into therapeutic classes, and for each class there is associated therewith known indications, contra-indications, recommended dosages, known adverse reactions, and drug interactions.

Each drug represented in the clinical database is assigned a unique identification code, preferably eight characters in length. The code represents a therapeutic cross reference (TXR), which provides a reference or link to the therapeutic category of the drug as well as those of therapeutically related drugs within a similar therapeutic class. This allows the flexibility to provide access to the directly referenced information as well as to comparative information, such that a pharmacist may be more informed when making care decisions. Each TXR points directly to its associated disease indications and contra-indications, via a link to the ICD-9s (International Classification of Diseases) associated with the diseases.

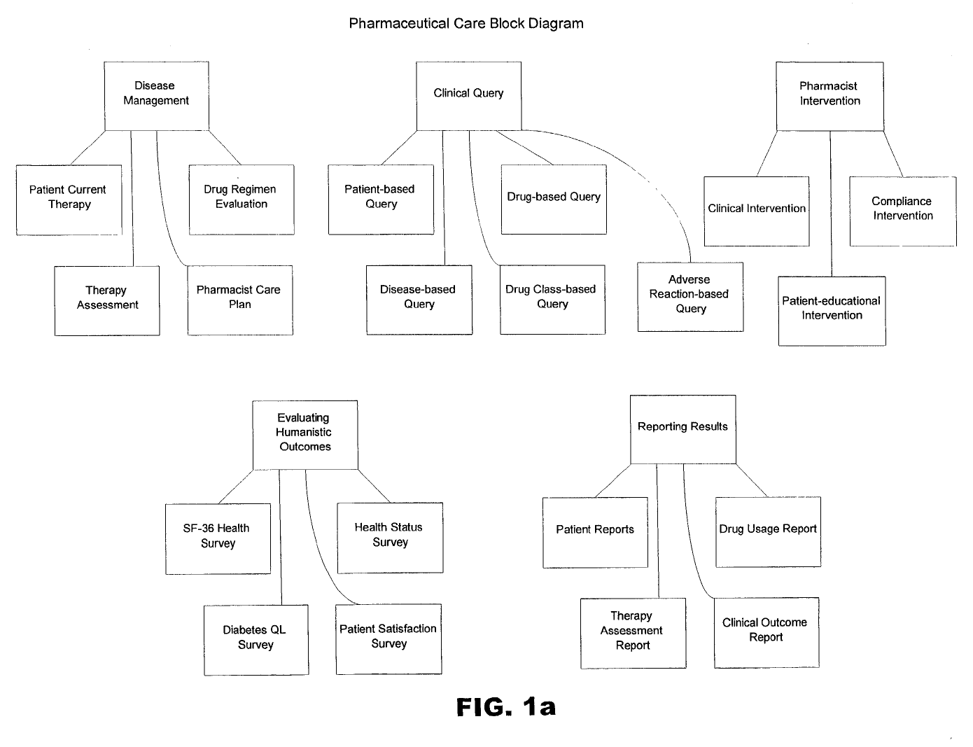

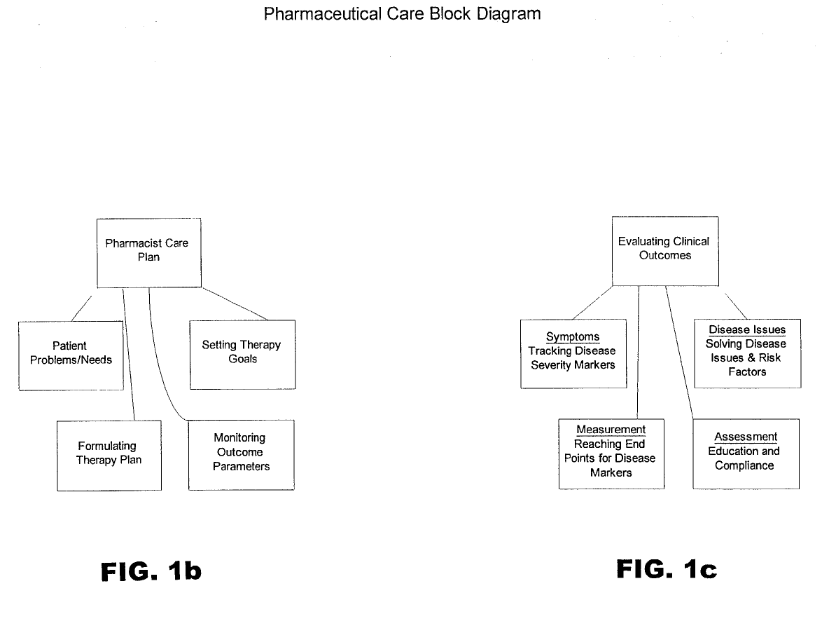

Using the clinical and patient data, the pharmacist is able to manage patient diseases (Disease Management), perform clinical queries to gather factual information (Clinical Query), document intervention in the patient treatment (Pharmacist Interventions), analyze and evaluate the results of patient therapy (Evaluating Humanistic and Clinical Outcomes), and report the results to necessary parties (Reporting Results), all through use of an integrated software solution. The main tasks, along with their associated sub-tasks, are shown in FIGS. 1a and 1b. In addition, FIG. 1c shows further subtasks of the subtask “Pharmacist Care Plan” shown in FIG. 1a. Each of these tasks will be discussed more fully herein.

### Disease Management

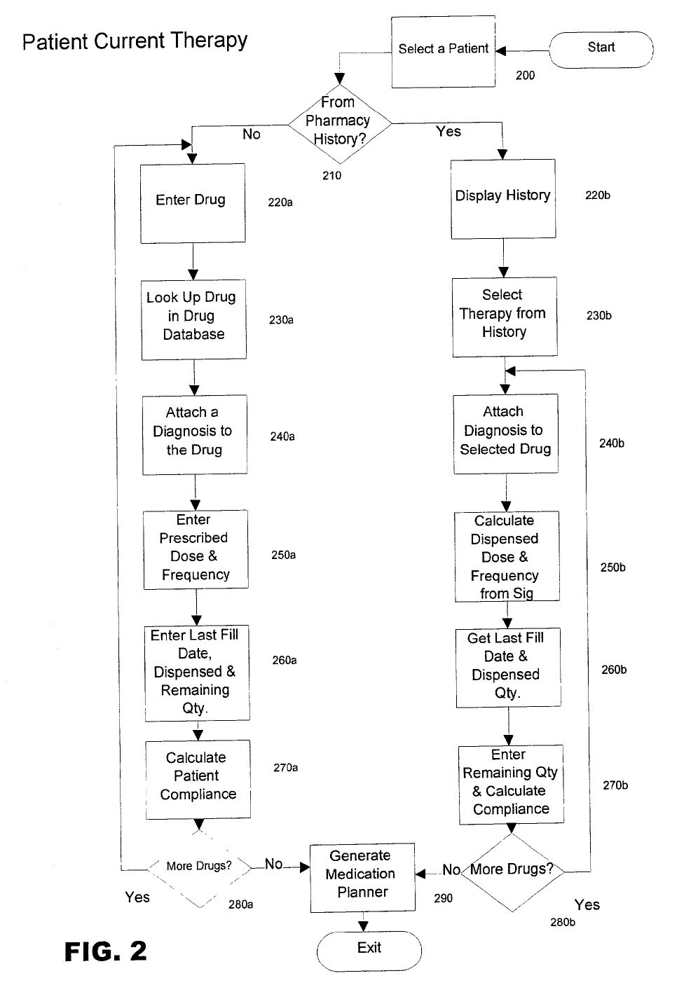

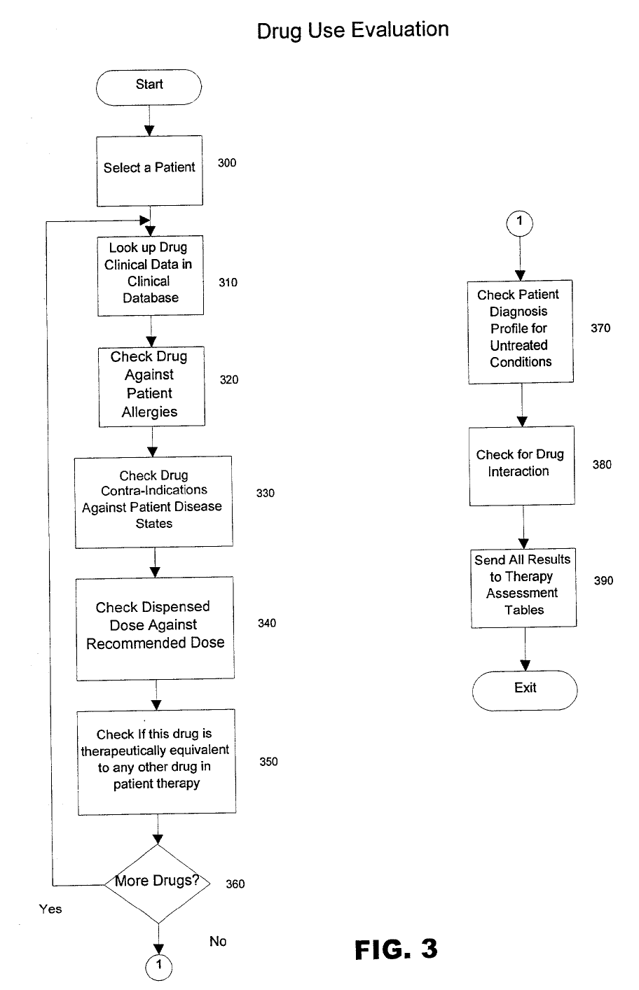

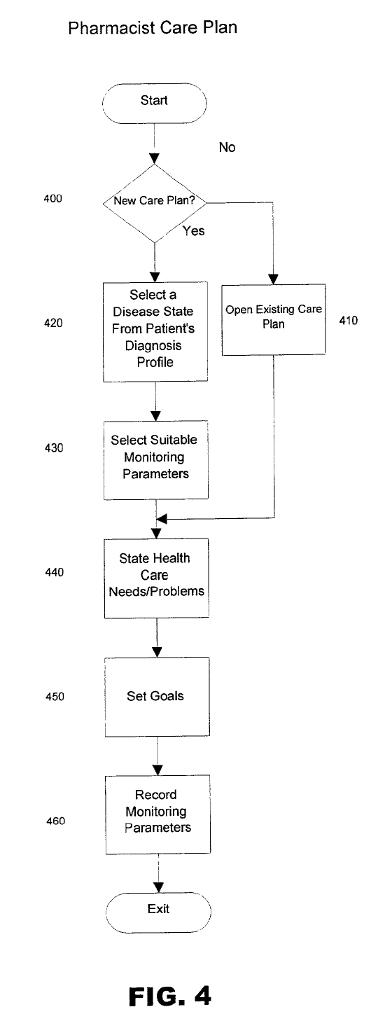

Disease management includes various interrelated activities designed to foster sound clinical decisions. For a selected patient, disease management includes documenting the patient's current drug therapy plan (Patient Current Therapy, see FIG. 2), evaluating the drug therapy in relation to the patient's indications (Drug Use Evaluation, see FIG. 3), determining any intervention necessary to correct the current therapy plan (Therapy Assessment), and constructing a plan to optimize the patient's therapy (Pharmacist Care Plan, see FIG. 4).

In FIG. 2, the steps followed to perform the Patient Current Therapy are shown. First, a particular patient is selected at step 200. The system determines if the selected patient already has information in the patient database, at step 210. If the patient is not already in the patient database, then the system proceeds down the path beginning with step 220a, otherwise the system proceeds down the path beginning with step 220b.

At step 220a, a particular drug in the patient's current therapy regimen is entered. The drug is entered in a table on a display device, such as a computer screen. The table comprises the following columns: drug name or description; usage direction or frequency per day (e.g. twice daily or 3 times daily); daily dose; date of last dispensing; the quantity dispensed; the quantity remaining; and Compliance percentage. The data can either be entered manually, or imported from a pharmacy dispensing system using one of several import/export mechanisms. The compliance percentage, however, is preferably automatically calculated based on the following formula:

Quantity Used=Quantity Dispensed−Quantity Remaining

Daily Usage=Daily Dose*Frequency Per Day

Number of Days of Use=Evaluation Date−Date of Last Dispensing

Compliance Percentage=(Quantity Used*100)/(Daily Usage*Number of Days)

At step 230a, the drug is located in the clinical database, and at step 240a, a specific diagnosis of the patient is associated with the drug. The pharmacist then enters into the system the prescribed dose and frequency of the drug for the patient, at step 250a, and the last fill date, dispensed date, and remaining quantities at step 260a. Patient compliance is calculated at step 270a, as described above. At step 280a, the pharmacist indicates whether there are more drugs in the patient's current therapy, and if so, the process is repeated for each drug. When there are no more drugs in the patient's current therapy, a medication planner is generated at step 290, to aid the patient or care provider in administering the proper doses of the therapy drugs and the proper times.

Still referring to FIG. 2, if the patient's information is already in the patient database, then after step 210 the method proceeds down the path beginning with step 220b. At step 220b, the patient's history is retrieved, and displayed on a computer screen or other display device. The particular therapy for the patient is selected from the history, at step 230b, and then at step 240b as specific diagnosis of the patient is associated with a selected drug in the therapy. The dispensed dose and frequency of the selected drug for the patient is calculated at step 250a by using administration instructions, and the last fill date, dispensed date, and remaining quantities are retrieved from the therapy information at step 260b. Patient compliance is calculated at step 270b, after the remaining quantity of the selected drug is input to the system by the pharmacist. At step 280b, the pharmacist indicates whether there are more drugs in the patient's current therapy, and if so, the process is repeated for each drug. When there are no more drugs in the patient's current therapy, a medication planner is generated at step 290.

FIG. 3 illustrates the steps involved in the Drug Use Evaluation portion of the Disease Management aspect of the present invention. In general, the present invention uses the clinical databases to match the patient's drug therapy against his/her medical conditions or existing disease states. Drug-disease contraindications, drug allergies, dose irregularities, therapeutic duplications, potential drug-drug interactions, and untreated medical conditions are also screened for, and patient compliance with the therapy plan is evaluated. The results of this clinically intensive process are produced almost instantaneously onto a display unit or other output device.

At step 300, information for the desired patient is selected to be displayed. Starting with the first drug in the patient's current therapy plan, at step 310 the drug's clinical data is retrieved from the clinical database. At step 320, the drug is then checked against the patient's allergy conditions, obtained from the allergy profile within the patient database. Any detected cross-allergies are flagged for later use and/or reporting. At step 330, the drug's contraindications are checked against the patient's disease states located in the patient diagnosis profile. Contra-indications, if any, are also flagged. At step 340, the dose specified for the selected drug is checked against the recommended dose in the clinical database, and any dosage outside the recommended range is flagged. For each drug, the clinical database contains specific indications to treat, and each indication has a specified maximum, minimum and normal range of dosages to be applied. The dose may vary depending on the patient's age, weight, and acuteness of the disease condition.

At step 350, the selected drug is compared to other drugs in the patient's therapy to determine if the selected drug is a therapeutic duplication of any of the other drugs in the patient's current therapy. This can be accomplished because the clinical database classifies the drugs into therapeutic classes, for which generally each drug in the class can be used for the same indications. If more than one drug in a particular class is in the patient's current therapy, the condition is flagged. If there are more drugs, as determined at step 360, the previous process is repeated, otherwise, the process continues to step 370, where the patient diagnosis profile is checked for untreated conditions. Since each drug is assigned a disease state from the patient's diagnosis profile to treat, any disease states in the patient's diagnosis profile that are not associated with one or more drugs are flagged as untreated medical conditions. The patient's current therapy is then reviewed at step 380, to determine if there are any drug interactions between two or more drugs. The clinical database documents these instances for each drug or drug combination, including the severity and frequency of occurrences. Each two drug combination is analyzed, and other multiple combinations of three or more drugs may also be analyzed. Any interactions are flagged, and all the information from the Drug Use Evaluation is forwarded at step 390 to the Therapy Assessment Tables for later use, as will be described herein. The information preferably includes the severity mechanism and suggested management.

The Therapy Assessment portion of the Disease Management aspect of the present invention is performed using data gathered and formed form the Drug Use Evaluation, as described above. The clinical database may be accessed during this process to review a particular drug regimen and provide a report regarding drug related problems associated with the regimen. The Therapy Assessment process is preferably divided into twelve assessment categories, although there may be more or less as desired or needed. Each category preferably corresponds to a page tab on a multi-tab folder on a computer display, and preferably comprises the following sections: a problem description, intervention documentation, recommendation, response to documentation and the date of the action. Each category can have several problem entries with corresponding intervention, recommendation, response and date. The system provides this data entry format to facilitate documenting the findings in the assessment process.

The first category is Untreated Medical Condition. The problem section of this category is generally filled automatically by the Drug Use Evaluation process. The pharmacist documents any intervention taken, and records his recommendations to the physician as well as the physician's response to his recommendation, and the dates thereof.

The second category is Drugs Without Medical Indication. Through the process of Drug Use Evaluation, there might be a situation where a drug exists in the patient's drug regimen even though none of its indications exists in the patient's diagnosis profile. This may indicate an incomplete patient diagnosis profile or an unneeded drug in the patient's drug regimen. This condition, if it exists, is automatically documented in the problem section, and the other sections are left for the pharmacist to document any interventions, recommendations and responses.

The third category is Dosage, Route, Frequency, and Therapy Duration. Any dosage problems detected in the drug evaluation process are automatically documented in the problem section of this category. Problems with route, frequency, and therapy duration are added manually by the pharmacist in addition to any interventions, recommendations, and responses.

The fourth category is Therapeutic Duplication. As described earlier, drugs in the patient's drug regimen which are therapeutically equivalent are detected and documented automatically in the problem section of this category. The pharmacist inputs the data needed to fill in the other sections.

The fifth category is Drug-Disease Contra-Indications. Any contraindications determined in the Drug Use Evaluation process are automatically documented in the problem section of this category. The pharmacist inputs the data needed to fill in the other sections.

The sixth category is Drug Interactions. Detailed descriptions of the interaction between any drug combination in the patient's current therapy, are documented in the problem section. There may be multiple interactions, in which case the pharmacist may document any intervention taken to manage each interaction, along with his or her recommendations and the physician's responses thereto.

The seventh category is Drug Allergies/Intolerance. In the problem category of this category, to the allergies detected during the Drug Use Evaluation process are documented automatically. The pharmacist may add other cases of intolerance that the patient has encountered.

The eighth category is Adverse Drug Reactions. Any adverse drug reactions reported by the patient are documented in the problem section of this category.

The ninth category is Medication Safety Efficacy Issues, which is used to document issues related to the safe use of the drug or its efficacy.

The tenth category is Patient Compliance. Patient compliance problems are documented in this category, together with recommendations for improvements.

The eleventh category is Patient Knowledge/Education Needs. The pharmacist's assessment of the patient's knowledge and educational needs is documented here. Any problems are described, along with any interventions and recommendations for how to resolve or cope with the, problems.

The twelfth category is Social/Financial Considerations. This category is used to describe social and financial circumstances that may affect the outcome of the patient's therapy. Turning now to FIG. 4, there is seen a flowchart of The Pharmacist Care Plan portion of the Disease Management aspect of the present invention. This is the final phase of the Disease Management process. (A block diagram of the main subtasks of this process is also shown in FIG. 1b.) A pharmacist care plan is constructed to optimize the drug therapy for the patient and to provide a clinical record of any interventions performed. First, it must be determined at step 400 whether a new care plan is to be created, or whether the pharmacist would like to review an existing care plan. If the latter, then the existing care plan is located at step 410. Otherwise, the pharmacist selects a disease state of the patient for which a care plan will be created (step 420), and selects suitable monitoring parameters (step 430).

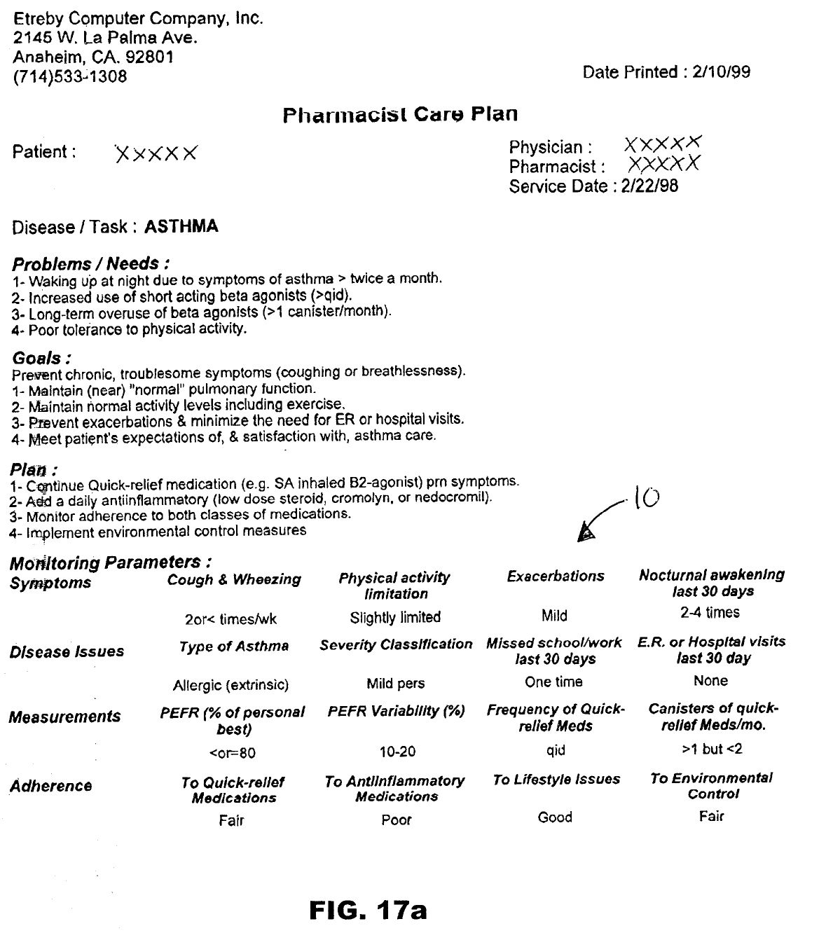

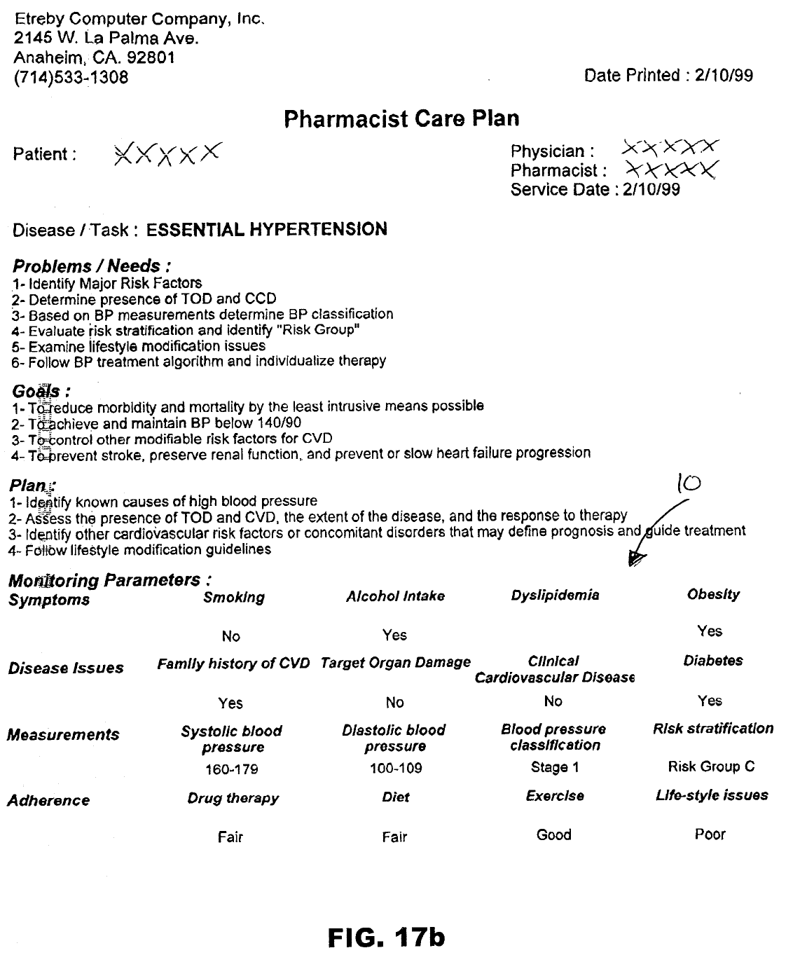

The monitoring parameters preferably include various symptoms, disease issues, measurements, and adherence ratings, as seen in the Monitoring Parameters section 10 of sample reports shown in FIGS. 17a and 17b. For each patient/pharmacist encounter addressing a particular care plan, a progress record is preferably created and attached to or electronically associated with the original care plan. A series of progress reports may then be created over time to provide history for tracking the outcome of the pharmaceutical care by comparative reporting of the monitoring parameters. The Pharmacist Care Plan then preferably comprises stating the patient's health care needs (step 440), setting pharmaceutical goals and recommending optimal therapy (step 450), and monitoring the outcomes (step 460).

All care plan sections are preferably presented together on the computer screen or other display device. The system allows the pharmacist to move freely between the different sections of the care plan. The system also presents the pharmacist with several buttons to initiate events to create patient or physician communications, access other care plans, access a protocol library, create and print invoices, access the knowledge base, and create progress notes.

A separate care plan may be constructed to address a single high-risk disease state. Another important feature is the ability to create multiple care plans for a patient suffering a multitude of high-risk conditions, with each plan addressing a separate disease state. To monitor the progress of the patient, as many progress notes as needed can be attached to the care plan.

To facilitate the development of care plans, the systems and methods of the present invention may include Care Plan Templates, Care Plan Protocols, a Communication Library, and an Online Knowledge Database.

The Care Plan Templates are used to save a care plan for a specific patient. The template can be used later for other patients with a similar high-risk condition.

Care Plan Protocols are developed to provide critical pathways and decision algorithms leading to the selection of optimal initial therapy and proper follow up criteria based on particular patient characteristics, co-existing medical conditions, severity of the disease, etc. Therefore, a protocol database provides the necessary guidelines for formulating the “plan” section of the care plan. The program provides the pharmacist several protocols for his/her use when creating care plans. The pharmacist may use these protocols as a guide for creating his/her own practice-specific protocols.

The Communications Library is a word processing tool that can be used to create custom messages for communicating with patients, patients' guardians or care givers, physicians, or other health care professionals. This feature saves enormous amounts of time. The library may contain a virtually endless number of pre-formatted messages for rapid retrieval and printing.

The Online Knowledge Base is periodically updated. Data provided may include basic reference information on selected high-risk disease states, easily made care plans, etc. Useful information, such as normal laboratory values or comparative safety and efficacy of certain drug categories are also included. The Online Knowledge Base is ideal for providing on-fine clinical guidelines during the process of setting up a pharmacist care plan. It provides assistance and guidance in identifying “patient problems/needs,” determining “pharmacotherapeutic goals,” setting a “plan,” and deciding upon the proper “monitoring parameters”. These are the distinct components of the Pharmacist Care Plan.

### Clinical Query

An important feature of the present invention is a robust array of integrated clinical databases. This advanced information technology provides virtually instant answers to very complicated clinical problems that face clinicians (physicians, pharmacists, nurses, etc.) in their daily practice.

The power of the clinical databases enable pharmacists to perform the “Drug Use Evaluation” process, as explained previously in the description of Disease Management. While this process happens in the background, for the “Clinical Query” these evaluations are brought to the foreground under the pharmacist's total control.

The “Clinical Query” may include Patient-based Queries, Disease-based Queries, Drug-based Queries, Drag class-based Queries, Adverse Reaction-based Queries, or other queries. The “Clinical Query” provides an innovative tool that can be used by the clinician to: find essential clinical information on a specific drug or class of drugs; find all drugs available under a specific therapeutic class; provide a virtually instantaneous comparison of clinical information between drugs in the same therapeutic class; find all drugs that can be used to treat a specific disease; find the most suitable drug(s) for use in treating a specific disease, taking into consideration a patient's other underlying conditions; find the most suitable drug(s) that can be used to treat a specific disease, taking into consideration other drugs in the patient's drug regimen; and trouble-shoot the existence of an adverse side effect that could possibly be caused by a drug in the patient's drug regimen, and suggest an alternate drug that does not cause the same side effect. Each of these clinical queries may be classified as a Patient-based Query, a Disease-based Query, a Drug-based Query, a Drug Class-based Query, or an Adverse Reaction-based Query.

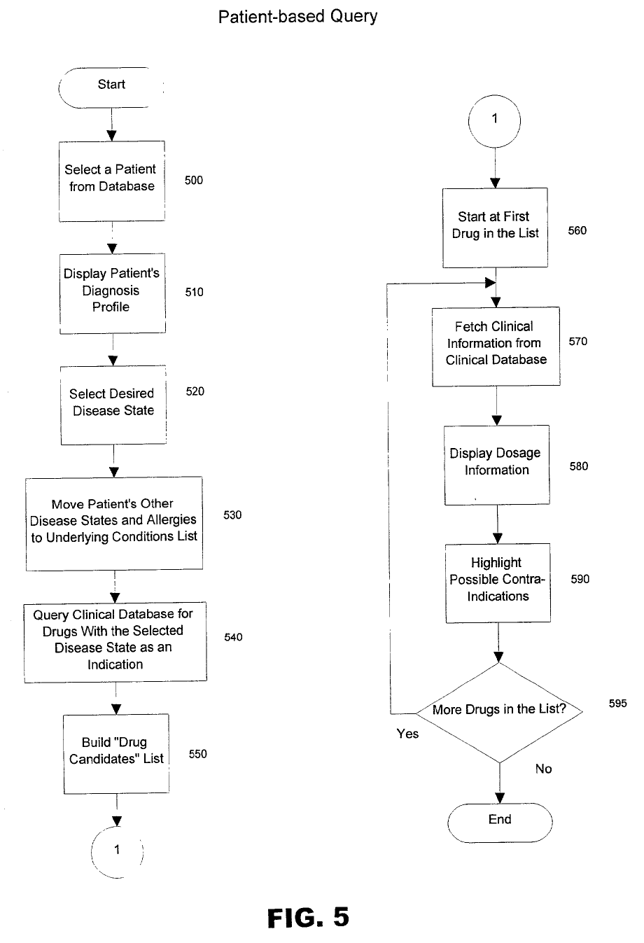

Patient-based Queries provide lists of all possible drug treatments for a given medical condition (diagnosis) of a selected patient, while in the meantime providing clinical “alerts” due to any of the patient's co-existing conditions (other disease states and allergies). This process is illustrated in FIG. 5.

At step 500, the pharmacist selects the patient from the patient database. The patient's existing disease states are displayed in a drop-down list, at step 510. The pharmacist then selects the desired disease state to be treated, at step 520. All other disease states of the patient (from the patient diagnosis profile) and all allergies of the patient (from the patient's allergy profile) are automatically listed in the patient's underlying conditions, at step 530. The system, at step 540, then queries the clinical database for all drugs that have the selected disease state among their indications, and then lists those drugs in a “Drug Candidates” list at step 550. For each drug in the list (as indicated by steps 560 and 595), the program fetches its clinical information from the database (step 570) and displays the dosage information, such as daily dose and frequency of administration (step 580), and highlights any detected contra-indications or allergy alerts based on the patient's underlying conditions (step 590). In the software implementation of the present invention, double clicking on any drug on the list will cause the software to display the detailed clinical information of the selected drug.

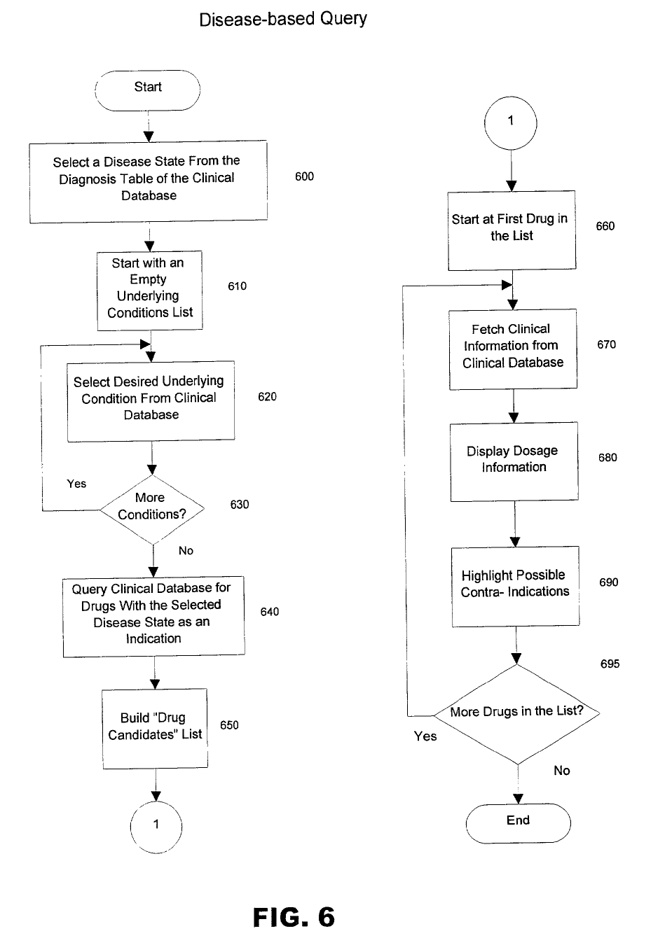

Disease-based Queries provide lists of possible drug treatments for a selected medical condition (diagnosis), while in the meantime providing clinical alerts due to any of a number of hypothetical co-existing conditions, not necessarily attached to a specific patient. This process is illustrated by the flowchart in FIG. 6.

At step 600, the pharmacist selects the desired disease state to be treated. The pharmacist then selects other disease states and allergies as underlying conditions, as seen by steps 610, 620, and 630. The system then queries the clinical database for all drugs that have the selected disease state among their indications (step 640), and lists those drugs in a “Drugs Candidates” list (step 650). For each drug in the list (as indicated by steps 660 and 695), the system fetches its clinical information from the database (step 670) and displays the dosage information, such as daily dose and frequency of administration (step 680), and highlights any detected contra-indications or allergy alerts based on the patient underlying conditions (step 690). In the software implementation of the present invention, double clicking on any drug on the list will cause the software to display the detailed clinical information of the selected drug.

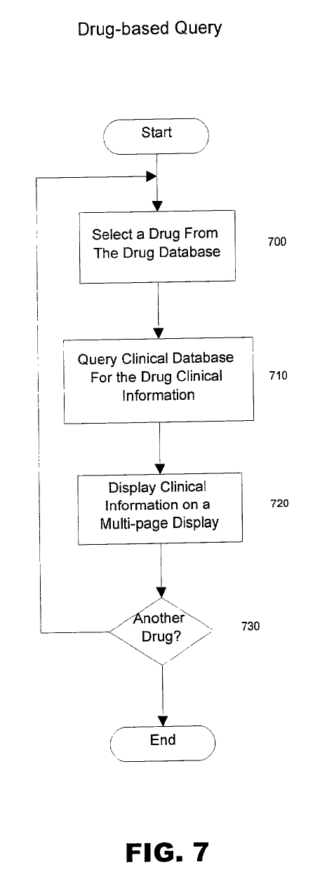

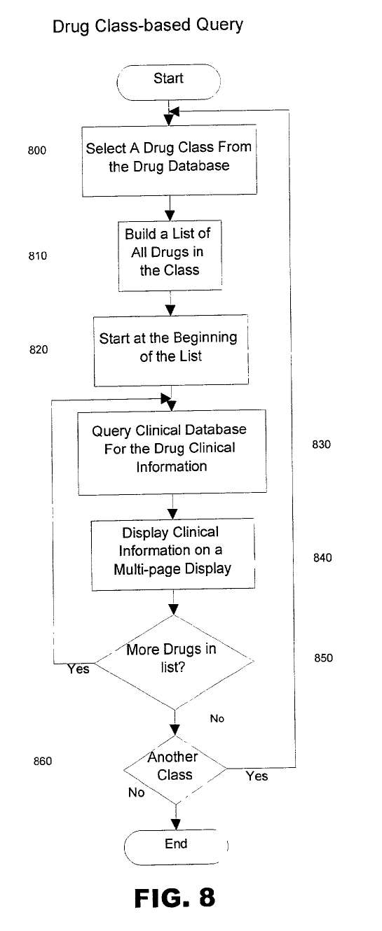

Drug-based Queries are used to access full prescribing information on any drug in the database and selectively zero in on the information category of special interest. The initial clinical display provides the selected drug's indications, recommended daily dose for each indication and the administrative frequency. Other displays provide the pertaining clinical information. This process is illustrated in FIG. 7.

The pharmacist selects a drug from the drug clinical database, as indicated at step 700, and the clinical database is accessed to retrieve information (step 710). At step 720, the system then lists, preferably on a multi-page display, the clinical information pertaining to the selected drug. The information includes indications, dosage information, contra-indications, adverse reactions, and other drugs that may interact with the selected drug. This process may be repeated for other drugs, as indicated by step 730.

Drug class-based queries are used to provide virtually instantaneous comparison among all drugs in a specific therapeutic class, providing full prescribing information on each drug in the class, enabling the pharmacist to selectively zero in on the information category of special interest. For each drug, the initial clinical display provides the indications, recommended daily dose for each indication and the administrative frequency. Other displays provide the pertaining clinical information on each drug for ease of comparison. The pharmacist first selects a drug class from the drug clinical database, as indicated by step 800. The system then lists all the drugs in this class (step 810) and searches the clinical database to fetch the clinical information on each drug, displaying the comparative clinical information on a multi-page display categorized by indications, contra-indications, adverse reactions and interactions (steps 820, 830, 840, and 850). On each page the relative severity and/or frequency of occurrence is displayed for meaningful comparison. The process may be repeated for more classes, as indicated by step 860.

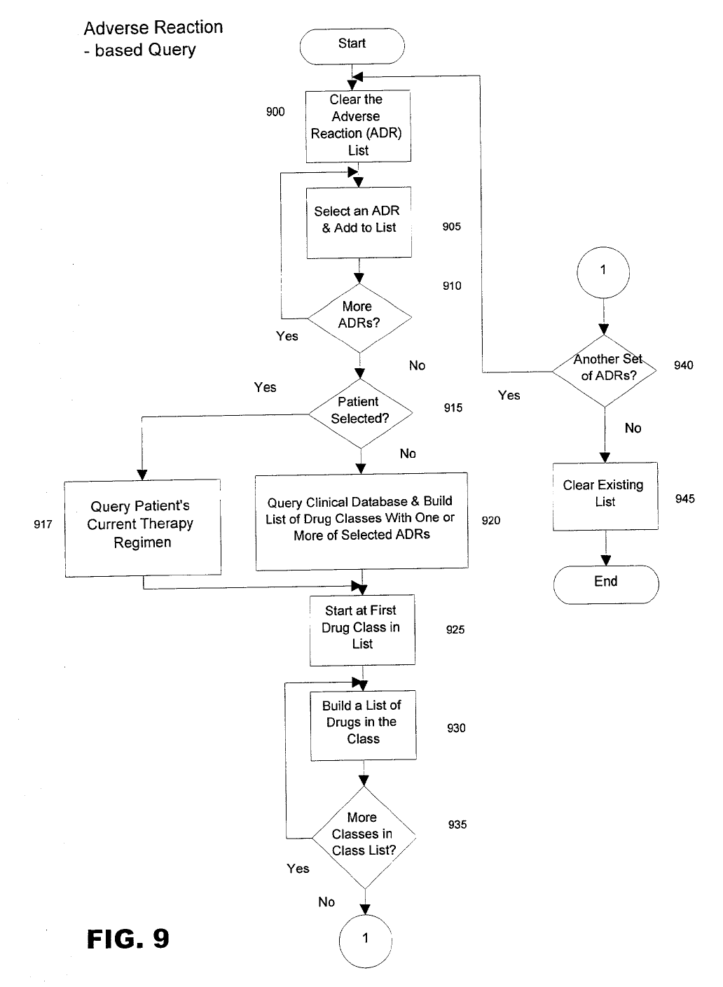

Adverse-reaction-based Queries are used to produce a list of therapeutic drug classes and selectively identify members of each therapeutic class and the likelihood to which they might cause a given adverse reaction. When a patient is involved in this process's criteria, the objective is to identify the drug(s) present in that patient's regimen that may cause a given adverse reaction. Turning to FIG. 9, the adverse reaction (ADR) list is cleared at step 900. The pharmacist then identifies the adverse reaction(s) at issue (steps 905 and 910). If a specific patient is selected for analysis at step 915, then the process continues to step 917, to be described shortly. Otherwise, the process continues at step 920, where the system then queries the clinical database for all therapeutic drug classes that may cause the ADR(s). A list is prepared comprising all drugs in the selected class that have associated therewith at least one of the ADRs. This is done for each selected class, as indicated by steps 925, 930, and 935. Once the process is complete for a particular set of ADRs, it may be repeated, as indicated by step 940. If there are no more ADRs to process, the Adverse reaction-based Query process ends (step 945).

If the pharmacist selects a particular patient from the patient database as a part of these query criteria (see step 915), then the drug search will be limited to the drugs in the selected patient's drug regimen, as indicated by step 917. In a software implementation of the present invention, upon highlighting a particular drug in the patient's current therapy, the system would preferably virtually instantaneously lists other members of the same drug class that may or may not cause the same reaction.

### Pharmacist Intervention

The pharmacist typically documents any interventions that he/she performs, such that the pharmacist can be compensated by the patient's insurance provider. The Pharmacist Intervention may include Clinical intervention, Patient Educational Intervention, or Compliance Intervention.

The system documents Clinical Interventions in a fast and efficient manner, and at the same time allows printing of claim forms which reflect the interventions. Two popular claim forms suitable for billing pharmacist intervention, HCFA-1500 and PCCF (NCPA's Pharmacist Care Claim Form), are preferably incorporated into the software system of the present invention. Both claim forms print on plain paper, thereby eliminating the need for pre-printed forms.

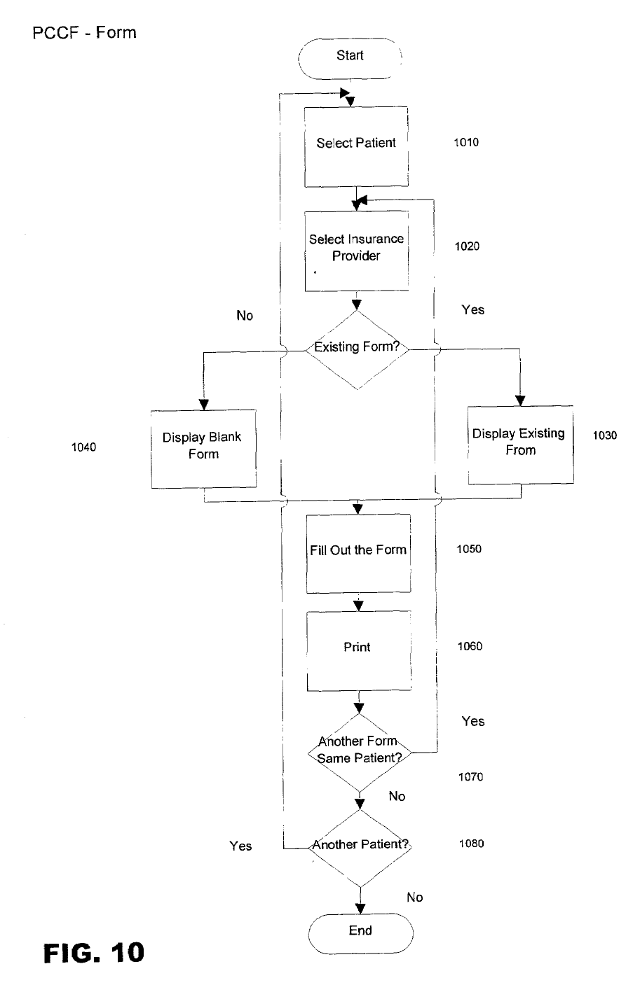

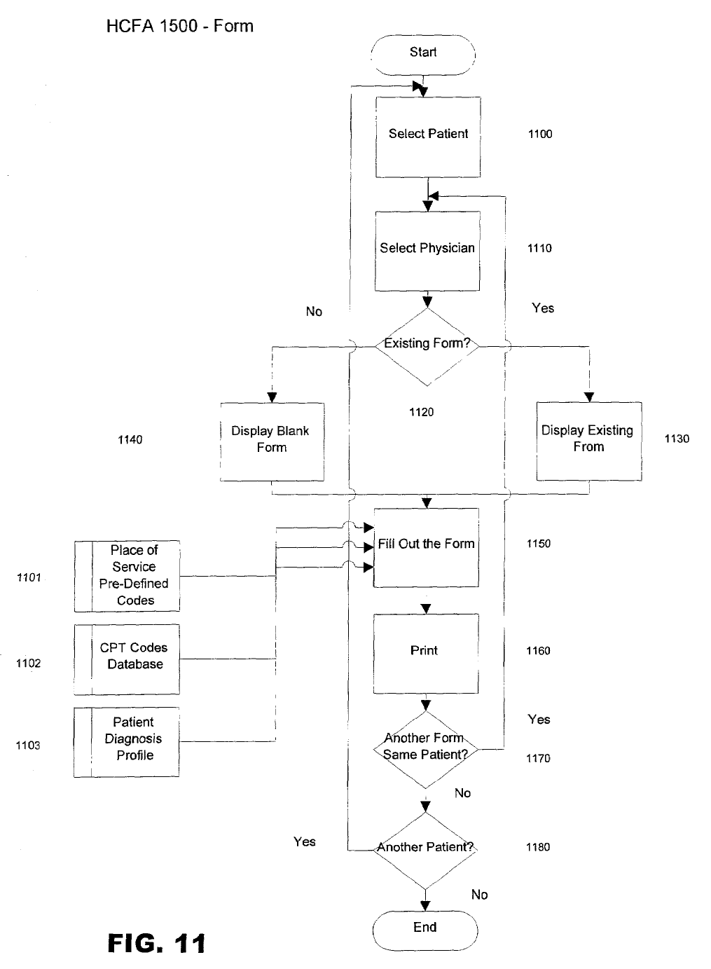

Using the systems and methods of the present invention, the pharmacist has the capability to fill the form on a display screen, using the patient's available demographic, insurance, and drug therapy information. Once the form is filled including the pharmacist fee of service, the form can be saved for later retrieval and/or printed for immediate use. The process involved is illustrated by the flowcharts in FIG. 10 and FIG. 11.

Turning to FIG. 10, for a PCCF Form, the patient is selected from the patient database, as indicated at step 1000, and the insurance provider is selected as indicated at step 1010, from the companies listed in the patient's insurance profile. At step 1020, the pharmacist may select to access an existing form, which is displayed at step 1030, or to create a new form at step 1040. If the pharmacist selects an existing form, it will be displayed exactly as it was saved previously, otherwise a blank form is displayed. At step 1050, the pharmacist then enters the necessary information on the forms. The forms are preferably broken into sections which are logically distributed among multiple pages of a screen display. The completed form may be saved to disk, and/or printed, as indicated by step 1060. This process may be repeated for multiple forms for a single patient (see step 1070), and for multiple patients (see step 1080).

Turning now to FIG. 11, for a HCFA-1500 Form, the patient is selected from the patient database at step 1100. The pharmacist then selects the patient physician from the physician's database, at step 1110. At step 1120, the pharmacist may select to access an existing form, which is displayed at step 1130, or to create a new form, at step 1140. If an existing form is selected, it will be displayed as it was saved previously; otherwise a blank form is displayed. At step 1150, the pharmacist then enters the necessary information on the form. The pharmacist is preferably aided in entering the information on the form, by selecting the proper entry from drop-down lists of information extracted from multiple databases in the system. The place of service field is extracted from a stored set of numeric codes representing various places of service (1201). The procedure codes are extracted from a CPT codes database 1102. The diagnosis codes are extracted from the patient's diagnosis profile, 1103. Upon completion of entering the information, the form may be stored on disk and/or printed at step 1160. This process may be repeated for multiple forms for a single patient (see step 1170), and for multiple patients (see step 1180).

Patient-educational Interventions are also documented in a fast and efficient manner. These interventions involve those performed by the pharmacist to educate the patient about the patient's medical condition or current drug therapy. This may include Patient Knowledge Assessment and Disease Specific Education. Patient Knowledge Assessment involves the patient's knowledge about his or her prescription, its intended use, expected action, etc. This information is assessed, and an educational action is taken during a counseling session. Documentation of this knowledge assessment and educational intervention is essential, and a screen-guided checklist is provided for this purpose. Disease Specific Patient Education involves the patient's knowledge about one of his disease states. This information is also assessed and an educational action is taken during a counseling session. For both of these processes, the on-screen form is filled out after selecting the patient from the patient database and the drug in question from his/her drug therapy. The form may then be saved on a disk or other media, and/or printed on a printer.

Patient Compliance Interventions are also documented in a fast and efficient manner. These interventions involve the pharmacist assessing the patient compliance with the patient's current therapy, and recommending actions to cure noncompliance. The process includes Compliance Assessment and Actions/Interventions. In the assessment section, the pharmacist performs an analysis to assess the reasons for a patient's non-compliance. Major problem areas are explored. In each problem area, several possibilities are identified. The pharmacist selects the possibility that best describes the reason of the patient non-compliance. Based on the assessment analysis and the pharmacist's knowledge of the patient's characteristics, certain steps may be taken to enhance compliance. Major action categories are explored in the actions or interventions section. In each category, several possible actions are identified. Again the pharmacist selects the possible actions that represent the intervention(s) likely to enhance the patient's compliance. Forms are filled out on the screen, after selecting the patient form the patent database. The forms may then be saved to disk or other storage media, and/or printed on a printer.

### Evaluating Outcomes

Improvement in a patient's quality of life is a desired outcome that may be a direct result of the provision of pharmaceutical care. The evaluation of the humanistic outcomes is done through the evaluation of the patient's responses to standardized surveys. Preferably, the following surveys are available to the patient as part of the systems and methods of the present invention: Short Form Health Survey (SF-36); Diabetes Quality of Life Surveys (DQOL); Patient Satisfaction Survey (PSQ18); and Health Status Survey. Although the surveys themselves are standardized, the methods in which they are completed and scored using a computer screen are not.

A survey is a questionnaire that may be administered through an interview or by giving a printed document to the patient for self-administration. These subjective measurements can be scored and analyzed as a valid and accurate assessment of the patient's perceived quality of life. Most surveys include several categories of questions pertaining to different aspects of the patient's quality of life. Each question has a few possible answers. Each answer is translated into a numerical value, which may have a range from 1 to 2, 1 to 3, 1 to 4, 1 to 5, 1 to 6, or any other numerical range.

The surveys may be completed by a pharmacist entering the data into the system based upon responses from the patient during an interview or counseling session, or the patient may complete a printed survey which is then later entered into the system. In either case, for each question, the pharmacist is presented with a drop-down list for the possible verbal answers to the question.

The Surveys are stored with their dates for later reference. Surveys taken at different dates can be printed or viewed on the screen. They can also be visually compared using bar graphs, which can also be printed.

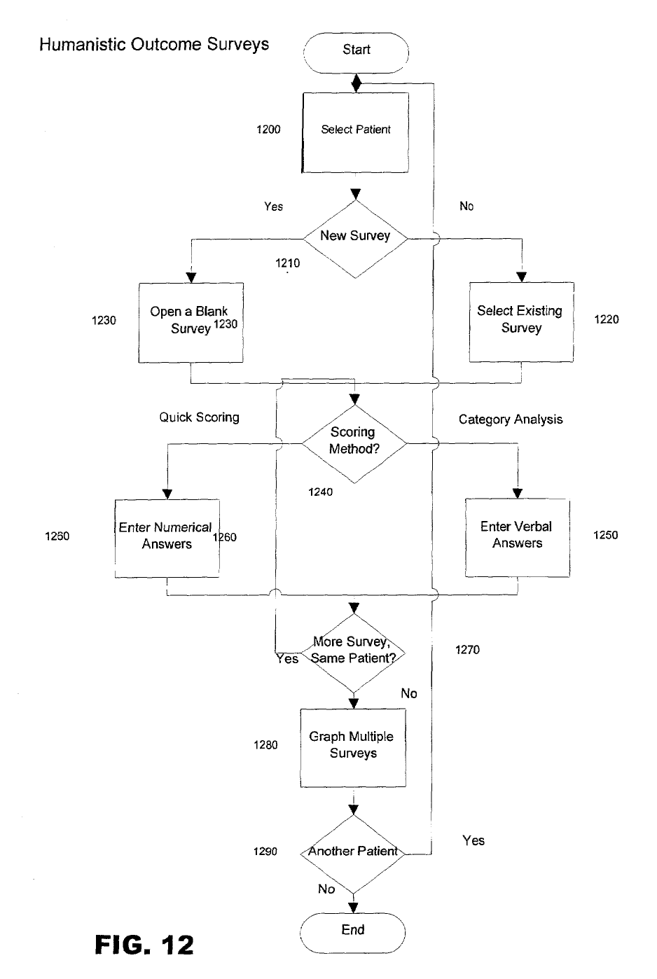

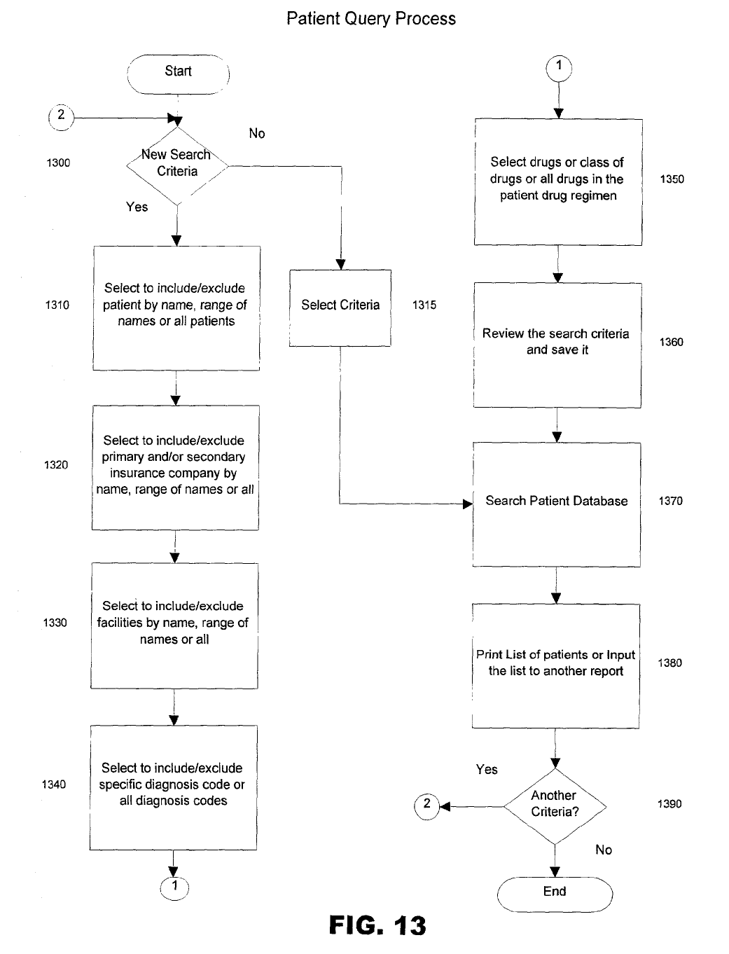

The process is illustrated by the flowchart in FIG. 12. The patient is selected at step 1200 from the patient database. If there are previous surveys filled for this patient, they are displayed in a drop-down list, form which the pharmacist can select a previous survey at step 1220 for analysis of the results. The pharmacist can enter a new survey at step 1230 by entering a new date for the survey. At step 1240, the pharmacist selects either the “Category Analysis” or the “Quick Scoring” method, and the process would proceed to step 1250 or 1260 respectively. The answers entered using one method can be instantaneously viewed using the other method. This process can be repeated as many times as needed for one patient with multiple surveys at different dates, as indicated by step 1270. The scores from all or some of the surveys may be graphed for visual comparison, at step 1280. The entire process may be repeated for another patient, as indicated by step 1290.

Additionally, Evaluating Clinical Outcomes is performed by using data gathered during patient encounters which data is automatically tabulated by the system in a comparative format and can be viewed on a display or a printed report. The data includes care plans and related progress notes. Sets of related parameters may also be viewed or printed in graph or table format. The main subtasks in Evaluating Clinical Outcomes are shown in FIG. 1c. Patient symptoms are tracked through the disease severity markers (e.g., coughing and wheezing for asthmatic patients). Also, Disease issues are resolved, and risk factors are eliminated or reduced. For example, for a diabetic patient a disease issue is whether the patient is overweight, and if so then to what degree. This is also a risk factor that is addressed in the care plan to help the patient reduce his or her weight. Parameters are also measured to evaluate a patient's progress towards reaching a desired goal. For example, for a hypertensive patient, their blood pressure is monitored regularly to assure the movement towards normal values for systolic and diastolic readings. Additionally, assessment of the patient's knowledge of their disease and therapy is performed, and the patient's compliance therewith is monitored.

### Reporting Results

The present invention includes a sophisticated reporting system that enables the pharmacist to obtain essential information to help the care provider in making critical decisions that affect health care delivery to the patient. The reports generated include Patient Reports, Drug Utilization Reports, Therapy Assessment Reports, and Clinical Outcome Reports.

Patient reports are generated using a patient query system as a front end, and the typical process is illustrated by the flowchart in FIG. 13. The patient query process allows the pharmacist to select patients from the patient database who meet specific criteria. The process begins at step 1300 where the pharmacist selects whether new search criteria are needed. If new search criteria are not needed, the pharmacist selects the existing criteria at step 1395. Otherwise, new criteria are selected. The criteria can be specified based on patient name (step 1310), primary and/or secondary insurance coverage (step 1320), patient location (step 1330), disease state(s) (step 1340), drug(s) taken (step 1350), and/or other parameters. The criteria established for a specific case study may be stored under an appropriate title to be retrieved for future study cases, as indicated at step 1360. The patient database is then searched at step 1370, and the results may be printed at step 1380. The process may be repeated, as indicated by step 1390. The patient query system, when used by itself, generates a list of patients meeting the specified criteria. If used as a front end to other reports, it only uses data obtained about those patients who met the criteria in generating the report.

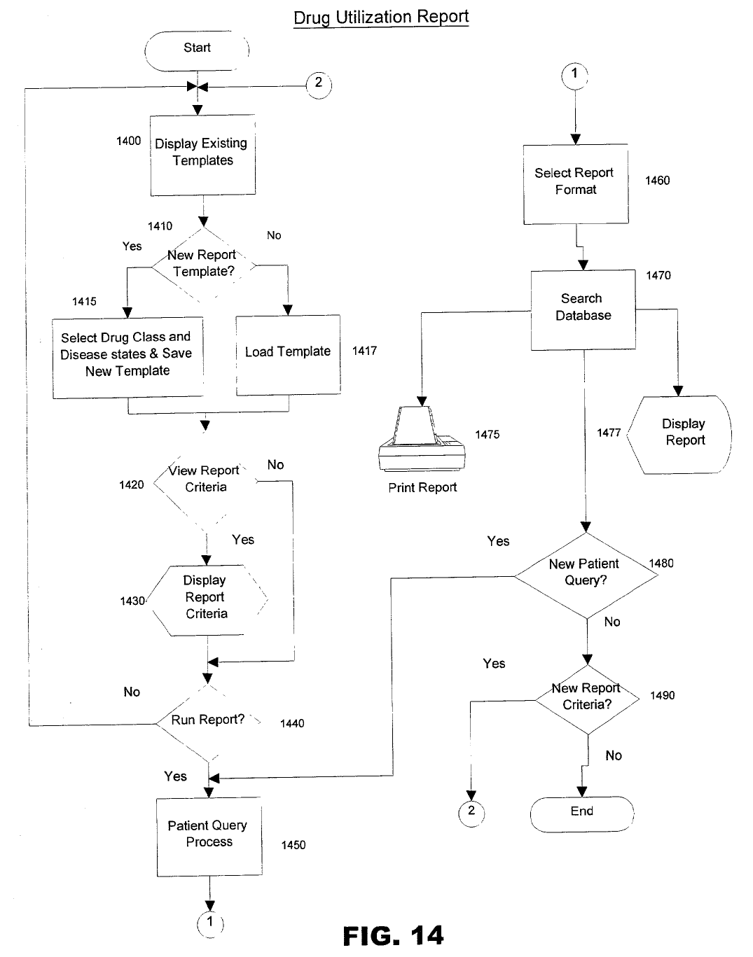

Drug Utilization reports display drug usage for specific classes of drugs, by a specific group of patients with specific disease state(s). The pharmacist has the capability of creating customized reports and saving them as templates for future use. He/she also has the option of displaying the report in summary format or in detailed format. The summary report is a statistical analysis that displays the total number of patients taking the drugs in the specified classes as well as the percentage of total patients selected. The detailed report includes the detailed information, such as the patient name, facility, etc. The process is shown by the flowchart in FIG. 14.

The process starts at step 1400 by displaying the existing report templates for the user to select among them. At step 1410, the user may select an existing report template or opt to create a new one. If the user selects an existing template, the process proceeds to step 1417 where the template is loaded, otherwise the process proceeds to step 1415 where the user selects the drug classes and disease states to report on. New templates may be saved for later use. The user can then view and/or print the template report criteria at steps 1420 and 1430 respectively, then proceed to run the report at step 1440 if desired. If a report is to be run, the patient query process is invoked as seen at step 1450. The user selects a report format and specifies the desired search criteria (step 1460) as explained in the patients report section, and the database is then searched (step 1470), wherein patient records, including the current drug therapies, are scanned (selected through the patient query process) to extract desired information. The result of the patient query process is printed and/or displayed (steps 1475 and 1477 respectively). The process using the already selected drug classes and disease states may be repeated for additional patients (step 1480), or the process may be restarted from the beginning (step 1490). There are numerous options that the user can use to customize the looks and the contents of the report.

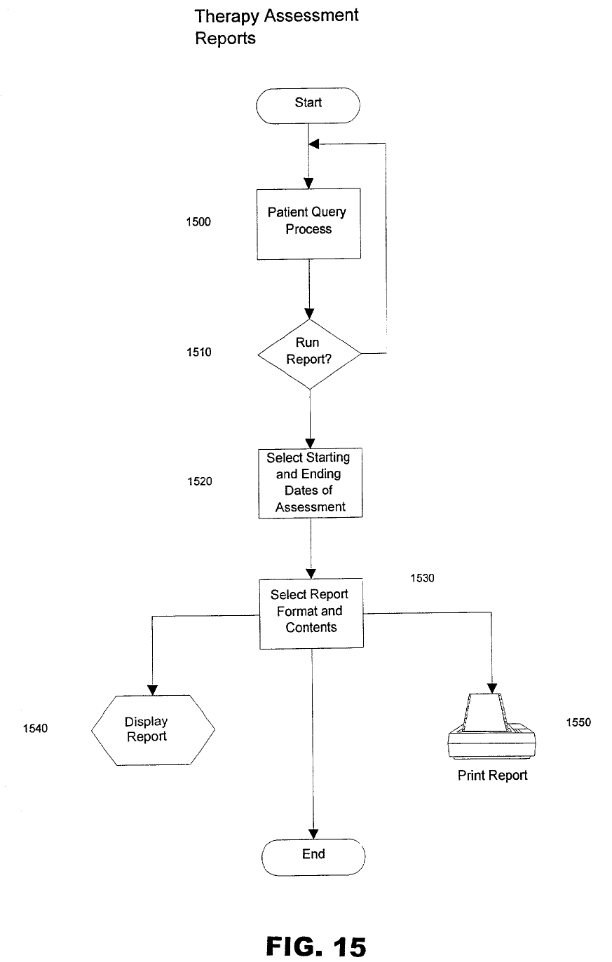

Therapy Assessment Reports show the therapy assessment report for patients selected via the patient query process. The pharmacist has the option of including in the report any combination of therapy assessment problem, intervention, response, and recommendation that he/she wishes. The pharmacist may also choose to print the report for each patient separately or include all patients in one report. The report can also be viewed and/or printed in a summary or detailed formats. The process is shown by the flowchart in FIG. 15. It begins at step 1500 by invoking the patient query process. Patients are selected via this process as explained in the patient report section. If a report is to be created as indicated by step 1510, the pharmacist specifies the starting and ending dates of the assessment (step 1520) and selects the report format and contents (step 1530). The records of the patients selected via the query process are scanned and their therapy assessment records are extracted. The report can then be displayed (step 1540) or printed on a printer (step 1550)

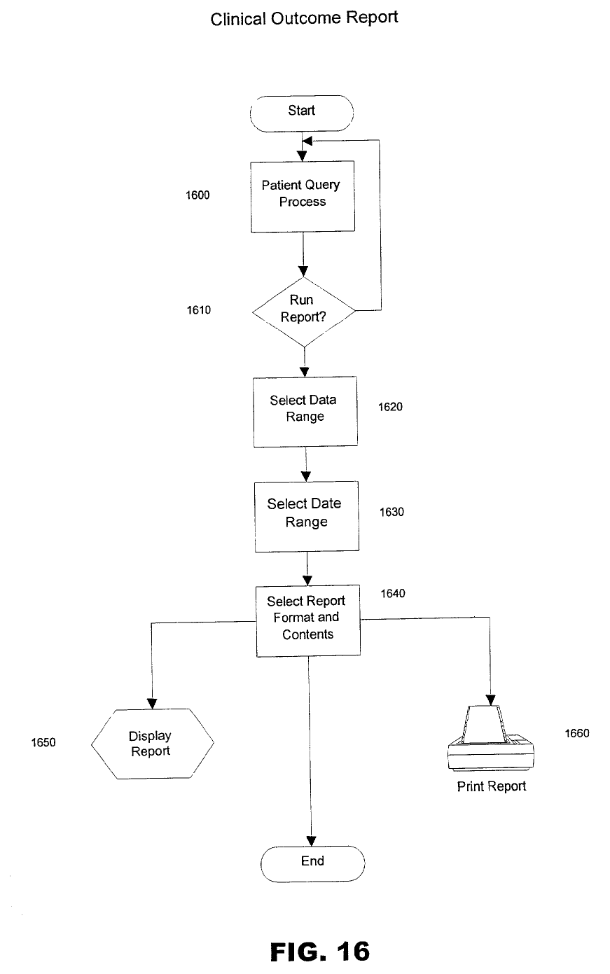

Clinical Outcome Reports are created as shown in FIG. 16. Data gathered during patient encounters are automatically tabulated by the system in a comparative format that can be viewed on the screen or printed in a report. Another way to look at clinical outcomes data is to graph separate sets of related parameters. The graph may be viewed on the screen or printed.

The report can be printed for one patient only for a particular care plan, or for a group of patients who share the same diagnosis for which care plans for each patient have been devised. The process of the report for one patient is to tally the information from the progress notes attached to this plan and display it on the screen and/or sent to a printer.

The process starts by invoking the patient query process at step 1600. Patients are selected via this process as explained in the patient report section. If a report is to be created, as indicated by step 1610, the pharmacist selects the desired diagnosis and specifies the data range at step 1620. The range may be, for example, the original care plan, the latest progress note, a specified number of the latest progress note, or specified number of progress notes including the original care plan. The pharmacist then selects the date range at step 1630, and selects a desired report format at step 1640. The records of the patients selected via the query process are scanned and their care plans and progress notes records are extracted. The report can then be displayed (step 1650) or printed on a printer (step 1660).

While certain embodiments are illustrated in the drawings and have just been described herein, it will be apparent to those skilled in the art that many modifications can be made to the embodiments without departing from the inventive concepts described. Thus, the invention is not to be restricted except by the claims which follow.

For example, the invention may be embodied in a single integrated software solution, to be run on any suitable local PC computer. Or the invention may be embodied in software accessible through the internet, or a dial-up connection. Similarly, the clinical data and/or the patient data may be in a single, or multiple databases, and they may be local or remote to a particular pharmacist. The database(s) may be controlled by a centralized database manager, such that pharmacists from various locations would have access to the same real-time data. Security levels may be programmed to allow specific individuals, or classes of individuals (i.e. doctors, patients, insurers, insured persons, etc.) specified access to specified functions. The pharmaceutical care software may operate in cooperation with an integrated or separate dispensing software. Any suitable programming language(s) may be used to provide a software implementation of the present invention. Also, various miscellaneous clerical, administrative, and even clinical functions may be added and/or deleted from those described herein. Functions may be organized in, various manners, other than that shown in FIG. 1. Various choices may include “other” or “miscellaneous”, and the system may be preprogrammed with default values. Also, “pharmacist” is used herein as a generic term for “user” when referring to the person performing the methods of the present invention.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. One or more computer-readable media having computer-usable instructions embodied thereon for performing a method of clinician disease management, the method comprising:
creating a current drug therapy plan for a patient using a clinical database;
evaluating the current drug therapy plan based on a relationship between the current drug therapy plan and at least one of one or more medical conditions associated with the patient and one or more existing disease states associated with the patient;
assessing the current drug therapy plan based at least in part on the evaluation to determine whether an intervention is necessary to correct the current drug therapy plan; and
constructing an optimization plan to optimize the current drug therapy plan,
wherein the current drug therapy plan is evaluated with one or more clinical queries including at least one of:
(i) a patient-based query configured to, upon receipt of an identification of the patient, present one or more possible drug treatments for a diagnosis of the patient and to provide one or more clinical alerts where the diagnosis of the patient conflicts with one or more co-existing conditions,
(ii) a disease-based query configured to, upon receipt of an identification of a disease, present one or more possible drug treatments for a diagnosis,
(iii) a drug-based query configured to, upon receipt of an identification of a drug, present a set of prescribing information associated with the drug,
(iv) a drug-class-based query configured to, upon receipt of an identification of a drug class, present a set of comparison information associated with one or more drugs in the drug class, and
(v) an adverse-reaction-based query configured to, upon receipt of an identification of an adverse reaction, present a set of reaction information associated with one or more therapeutic classes of drugs.

2. The computer-readable media of claim 1, wherein creating a current drug therapy plan for a patient using a clinical database comprises:
receiving a selection of the patient from a clinician;
presenting a set of historical drug therapy information associated with the patient;
receiving a selection of a drug from the set of historical drug therapy information;
associating a patient diagnosis with the drug;
automatically calculating dispensing information for the drug based on a set of administration instructions, a last fill date, a dispensed data, and a remaining quantity;
automatically calculating patient compliance; and
generating a medication planner associated with the patient.

3. The computer-readable media of claim 1, wherein creating a current drug therapy plan for a patient using a clinical database comprises:
receiving a selection of the patient from a clinician, the patient not already existing in the clinical database;
receiving an identification of a drug in the current drug therapy plan associated with the patient;
retrieving a set of information associated with the drug using the clinical database;
associating a patient diagnosis with the drug;
receiving a set of prescribed dose and frequency information;
receiving a last fill date, a dispensed date, and a remaining quantity;
automatically calculating patient compliance; and
generating a medication planner associated with the patient.

4. The computer-readable media of claim 1, wherein evaluating the current drug therapy plan comprises:
retrieving a set of clinical data associated with a drug in the current drug therapy plan from the clinical database;
checking the drug against one or more allergy conditions associated with the patient and flagging any detected cross-allergies;
checking the drug's contra-indications against the patient's disease states and flagging any detected contra-indications;
checking the dose specified for the drug against the recommended dose and flagging any dosage outside the recommended range;
comparing the drug against other drugs in the current drug therapy plan to determine whether the drug is a therapeutic duplication;
checking a diagnostic profile for the patient for untreated conditions; and
analyzing the current drug therapy plan to determine if there are any drug interactions between two or more drugs.

5. The computer-readable media of claim 1, wherein assessing the current drug therapy plan comprises:
presenting to a clinician one or more categories of assessment information,
wherein each category includes a problem description, an intervention documentation, a recommendation, a response to documentation, and an action date.

6. The computer-readable media of claim 5, wherein the one or more categories of assessment information include at least one of: (i) untreated medical condition; (ii) drugs without medical indication; (iii) dosage, route, frequency and therapy duration; (iv) therapeutic duplication; (v) drug-disease contra-indications; (vi) drug interactions; (vii) drug allergies/intolerance; (viii) adverse drug reactions; (ix) medication safety efficacy issues; (x) patient compliance; (xi) patient knowledge/education needs; and (xii) social/financial considerations.

7. The computer-readable media of claim 1, wherein constructing an optimization plan to optimize the current drug therapy plan comprises:
receiving a selection of a disease state associated with the patient;
receiving a selection of one or more monitoring parameters;
receiving a statement of the patient's health care needs;
receiving a selection setting pharmaceutical goals and recommended optimal therapy for the patient;
monitoring the outcomes of the optimized drug therapy plan; and
presenting the optimized drug therapy plan.

8. The computer-readable media of claim 7, wherein the one or more monitoring parameters include at least one of a symptom, a disease issue, a measurement, and an adherence rating.

9. The computer-readable media of claim 8, wherein construction of the optimization plan is facilitated using at least one of a care plan template, a care plan protocol, a communications library, and an online knowledge database.

10. One or more computer-readable media having computer-usable instructions embodied thereon for performing a method of clinician disease management, the method comprising:
creating a current drug therapy plan for a patient using a clinical database;
evaluating the current drug therapy plan based on a relationship between the current drug therapy plan and at least one of one or more medical conditions associated with the patient and one or more existing disease states associated with the patient using one or more clinical queries;
assessing the current drug therapy plan based at least in part on the evaluation and determining that an intervention is necessary to correct the current drug therapy plan; and
constructing a optimization plan to optimize the current drug therapy plan,
wherein the intervention is documented in the clinical database, and
wherein the intervention includes at least one of:
(i) a patient educational intervention for educating the patient about the patient's medical condition and the current drug therapy plan, and
(ii) a patient compliance intervention for assessing the patient's compliance with the current drug therapy plan and recommending actions to cure noncompliance.

11. The computer-readable media of claim 10, wherein creating a current drug therapy plan for a patient using a clinical database comprises:
receiving a selection of the patient from a clinician;
presenting a set of historical drug therapy information associated with the patient;
receiving a selection of a drug from the set of historical drug therapy information;
associating a patient diagnosis with a drug;
automatically calculating dispensing information for the drug based on a set of administration instructions, a last fill date, a dispensed data, and a remaining quantity;
automatically calculating patient compliance based on the remaining quantity; and
generating a medication planner associated with the patient.

12. The computer-readable media of claim 10, wherein creating a current drug therapy plan for a patient using a clinical database comprises:
receiving a selection of the patient from a clinician, the patient not already existing in the clinical database;
receiving an identification of a drug in the current drug therapy plan associated with the patient;
retrieving a set of information associated with the drug using the clinical database;
associating a patient diagnosis with the drug;
receiving a set of prescribed dose and frequency information;
receiving a last fill date, a dispensed date, and a remaining quantity;
automatically calculating patient compliance; and
generating a medication planner associated with the patient.

13. The computer-readable media of claim 11, wherein evaluating the current drug therapy plan comprises:
retrieving a set of clinical data associated with a drug in the current drug therapy plan from the clinical database;
checking the drug against one or more allergy conditions associated with the patient and flagging any detected cross-allergies;
checking the drug's contra-indications against the patient's disease states and flagging any detected contra-indications;
checking the dose specified for the drug against the recommended dose and flagging any dosage outside the recommended range;
comparing the drug against other drugs in the current drug therapy plan to determine whether the drug is a therapeutic duplication;
checking a diagnostic profile for the patient for untreated conditions; and
analyzing the current drug therapy plan to determine if there are any drug interactions between two or more drugs.

14. The computer-readable media of claim 13, wherein assessing the current drug therapy plan comprises:
presenting to a clinician one or more categories of assessment information,
wherein each category includes a problem description, an intervention documentation, a recommendation, a response to documentation, and an action date.

15. The computer-readable media of claim 14, wherein the one or more categories of assessment information include at least one of: (i) untreated medical condition; (ii) drugs without medical indication; (iii) dosage, route, frequency and therapy duration; (iv) therapeutic duplication; (v) drug-disease contra-indications; (vi) drug interactions; (vii) drug allergies/intolerance; (viii) adverse drug reactions; (ix) medication safety efficacy issues; (x) patient compliance; (xi) patient knowledge/education needs; and (xii) social/financial considerations.

16. The computer-readable media of claim 15, wherein constructing an optimization plan to optimize the current drug therapy plan comprises:
receiving a selection of a disease state associated with the patient;
receiving a selection of one or more monitoring parameters;
receiving a statement of the patient's health care needs;
receiving a selection setting pharmaceutical goals and recommended optimal therapy for the patient;
monitoring the outcomes of the optimized drug therapy plan; and
presenting the optimized drug therapy plan.

17. The computer-readable media of claim 16, wherein the one or more monitoring parameters include at least one of a symptom, a disease issue, a measurement, and an adherence rating.

18. The computer-readable media of claim 17, wherein construction of the optimization plan is facilitated using at least one of a care plan template, a care plan protocol, a communications library, and an online knowledge database.

19. One or more computer-readable media having computer-usable instructions embodied thereon for performing a method of managing patient compliance and intervention, the method comprising:
receiving an indication from a clinician that a patient may not be complying with a current drug therapy plan;
presenting the clinician with one or more major problem areas, each problem area outlining one or more possibilities for non-compliance;
receiving a selection from the clinician of at least one of the one or more possibilities for non-compliance that best describes the reasons for the patient's non-compliance;
presenting the clinician with one or more major action areas, each action area outlining one or more possible actions;
receiving a selection from the clinician of at least one of the one or more possible actions that represent at least one intervention likely to enhance the patient's compliance; and
storing a set of compliance information and a set of intervention information on a clinical database in association with the patient and the patient's current drug therapy plan.

20. The computer-readable media of claim 19, wherein the set of compliance information and the set of intervention information is stored by prompting the clinician with one or more forms and storing the forms with information added by the clinician.
